(19) United States
(12) Patent Application Publication
(10) Pub. No.: US 2006/0109762 A1
(43) Pub. Date: May 25, 2006

(54) Method and apparatus for recording and/or reproducing information

(76) Inventor: Johannis Friso Rendert Blacquiere, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/531,032

(22) PCT Filed: Sep. 19, 2003
(86) PCT No.: PCT/IB03/04267

§ 371 Date: Apr. 12, 2005

(30) Foreign Application Priority Data
Oct. 14, 2002 (EP) 02079325.3

(51) Int. Cl. G11B 15/18

(52) U.S. Cl. 369/47.38

(57) ABSTRACT

The invention described relates to a method and apparatus for recording and/or reproducing information on an information track of an information disc. The method comprising the steps of: a) directing a read-write-head to a current radial position along of the information disc, b) rotating the information disc about a point of rotation, where the rotation speed is controlled in dependence of the current radial position of the read-write-head such that the information passes the read-write-head at a predetermined constant linear velocity, at least for a part of the information track, c) performing a current read-write-action at the current radial position, d) directing the read-write-head to a next radial position along the information disc, where the rotation speed is controlled such that a current rotation speed is changed to a target rotation speed to attain said predetermined constant linear velocity at the next radial position, e) performing a next read-write-action at the next radial position, characterized in that the method further comprises the steps of, f) determining the next radial position of the read-write-head while still performing the current read-write-action, g) determining the target rotation speed on the basis of the next radial position, the current rotation speed being changed towards the target rotation speed while the current read-write-action is still being performed. The information disc rotates with a constant angular velocity (CLV). When jumping from one track to another track the speed is already changed before the actual jumping is performed and the current read-write-action is still being performed. This results in a time gain because the rotation speed of the information disc is sooner achieved, so that the next read-write-action can be performed sooner.

The invention relates to a method for recording and/or reproducing information on an information track of an information disc, comprising the steps of:

a. directing a read-write-head to a current radial position along of the information disc,

b. rotating the information disc about a point of rotation, where the rotation speed is controlled in dependence of the current radial position of the read-write-head such that the information passes the read-write-head at a predetermined constant linear velocity, at least for a part of the information track,

c. performing a current read-write-action at the current radial position,

d. directing the read-write-head to a next radial position along the information disc, where the rotation speed is controlled such that a current rotation speed is changed to a target rotation speed to attain said predetermined constant linear velocity at the next radial position,

e. performing a next read-write-action at the next radial position.

The invention further relates to an apparatus for recording and/or reproducing information on an information track of an information disc, comprising:

a read-write-head for performing read-write-actions on the information disc;

handling means for controlling the read-write-actions;

radial servo means for moving said read-write-head along a radial direction of the information disc;

rotation means for rotating said information disc about a point of rotation;

controlling means for controlling the rotation means where the controlling means control the current rotation speed in dependence of a current radial position of the read-write-head such that the information passes the read-write-head at a constant linear velocity, at least for a part of the information track, and where the controlling means are arranged to change the current rotation speed suitable for a current read-write-action on a current radial position to a target rotation speed suitable for a next read-write-action on a next radial position.

In U.S. Pat. No. 5,561,644 an optical disk apparatus for recording and/or reproducing information on a disk recording medium is described. The disk recording medium is rotated with a constant linear velocity (CLV). The information is read from or written to the disk recording medium by an optical pickup unit. The optical pickup unit projects a laser beam on the surface of the disk recording medium. The laser beam is reflected by the surface and subsequently projected onto a detector in the optical pickup unit. The signal coming from the detector is used to regenerate the information stored on the disk recording medium. The known optical disk apparatus has a first signal indicating the rotational speed of the disk recording medium and a second signal indicating the speed at which information on the disk recording medium passes along the optical pickup unit. In normal operation the rotational speed of the disk recording medium is controlled by using the second signal such that the information passes the optical pickup unit at a constant linear velocity. When the optical pickup unit is moved from a current radial position to a next radial position, the rotational speed of the disk recording medium is controlled by using the first signal, thereby increasing or decreasing the current rotational speed to a target rotational speed. The target rotational speed is such that at the next radial position the linear velocity is equal to the constant linear velocity, and is therefore dependent on the radial location of the next radial position. The increasing or decreasing of the current rotational speed is performed when it is detected by the output of position detecting means that the optical pickup unit moves to the next radial position.

When the optical pickup unit jumps to a next radial position which is relatively far away from the current radial position, then the difference between the current rotational speed and the target rotational speed is relatively large. Therefore, after the optical pickup unit has arrived at the next radial position the current rotational speed is not yet equal to the target rotational speed. The known apparatus has to wait until the current rotational speed has arrived at the target rotational speed to start a read-write-action. A read-write-action is an action of the read-write-head to read or write information from or to the information disc. This waiting time contributes to the access performance of the apparatus. Access performance is the average time that is required to retrieve or write information from or to the information disc.

It is an object of the invention to provide a method for recording and/or reproducing information which has an improved access performance.

It is a further object of the invention to provide an apparatus for recording and/or reproducing information which has an improved access performance.

The object is realized with a method according to the opening paragraph where the next radial position of the read-write-head is known while still performing the current read-write-action and where the target rotation speed is determined on the basis of the next radial position, and where the current rotation speed is being changed towards the target rotation speed while the current read-write-action is still being performed. The rotation speeds at which a read-write-action can be performed correctly differs for various kinds of read-write-actions. At least for some read-write-actions the rotation speed can be varied in a certain range without the read-write-action being disturbed. The inventor has had the insight that this range can be used to already increase or decrease the current rotation speed towards the target rotation speed when still performing the current read-write-action, to decrease the amount of time needed to arrive at the target rotation speed. It may be that there is some time lost due to extra time needed to conclude the current read-write-action, but the time needed for arriving at the target rotation speed is shortened. Dependent on the difference between the target rotation speed and the current rotation speed at the end of the current read-write-action, the gain of time can be more than the extra time needed for finishing the current read-write-action, resulting in a net time gain.

The further object is realized with an apparatus according to the opening paragraph where the controlling means comprise retrieving means for retrieving the next radial position while still performing the current read-write-action and where the controlling means are arranged to change the current rotational speed towards the target rotation speed before the current read-write-action has ended. With this apparatus the next radial position is already known while still performing the current read-write-action. This information is used to already increase or decrease the current rotation speed towards the target rotation speed. This again leads to a time gain, and thus to an improved access time.

In order to have a maximum gain in time an advantageous embodiment of the method of the invention changes the current rotation speed towards the target rotation speed such that at the end of the current read-write-action the rotation speed is just within limits at which the current read-write action can be performed correctly. This has the advantage that the rotation speed at the end of the current read-write-action is maximally increased or decreased towards the target rotation speed. The time required to arrive at the target rotation speed, measured from the end of the current read-write-action, is then reduced to a minimum. Of course, this strategy is only advantageous when the time needed for the read-write-head to arrive at the next radial position substantially smaller the time needed to increase or decrease the current rotation speed to the target rotation speed. When the read-write-head takes longer to arrive at the next radial position than it is not necessary to change the current rotation speed as soon as possible. A strategy where the current rotation speed is changed later than the soonest possible moment and before the end of the current read-write-action is then sufficient.

In a further embodiment of the apparatus according to the invention the controlling means are arranged to adapt the current rotation speed is changed towards the target rotation speed such that at the end of the current read-write-action the rotation speed is just within limits at which the current read-write action can be performed correctly. This has the advantage as discussed in the previous method.

In a further embodiment of the method according to the invention the next read-write-action is started before the target rotation speed has been reached. Here, the range at which the next read-write-action can still perform correctly is used to gain time. Because a part of the read-write-action is already concluded before the current rotation speed is equal to the target rotation speed there is a time gain. The time gain is equal to the time that would be required to conclude the same part as mentioned above, but at a rotation speed that is controlled at the constant linear velocity.

Similarly, in a further embodiment of the apparatus according to the invention the handling means are arranged to start the next read-write action before the target rotation speed has been reached. The maximum time gain is achieved by starting the next read-write-action immediately when the current rotation speed is within limits at which the next read-write-action can be performed correctly. Thus the next read-write-action is started as soon as possible, resulting in a maximum time gain.

In a further embodiment the method according to the invention performs the steps a to g when receiving a command to read a file and wherein the next radial position is retrieved from a file system indicating locations of different parts of the file on the information disc. On the information disc a part of the information track is reserved for storing a list of files which are stored on the information disc. Also the location of the files is stored on the information track. It is possible that one file is located at different locations of the information track. An example of a file system is the ISO 9660 standard. ISO 9660 specifies a file system that is used, among others, on IBM PC-compatible systems, and has been included in CD standards. ISO 9660 defines a hierarchical file structure.

Similarly, in a further embodiment of the apparatus according to the invention the information disc comprises file information which indicates locations of different parts of a file and in that the apparatus further comprises file information retrieving means for retrieving the file information and in that the retrieving means are arranged to determine the next radial position based on the retrieved file information.

In computer systems many information is recorded or reproduced on an information disc. The rewritable compact disc recorder is an example of an apparatus that is used by a computer system to store and retrieve information. The computer system gives commands to the recorder to read information from or write information to the compact disc. In a further embodiment of the invention the method comprises a step of receiving commands from information processing means where the commands contain at least one read-write-action instruction, where a next command is already received while still executing a current command, and in that the next radial position is derived from the next command.

Similarly, in a further embodiment of the apparatus according to the invention the handling means are arranged to receive commands containing at least one read-write-action instruction, and where the handling means comprise storing means for storing a next command, and in that the retrieving means are arranged to determine the next radial position based on the next command. The commands that the handling means receive may be sent by information processing means. The information processing means are an apparatus that processes the information that has to be written to the information disc, or that has to be read from the information disc. In the example of the rewritable compact disc player the information processing means are the computer system. The commands coming from the information processing means comprise read-write-actions that are executed according to the method of the invention. By already receiving the next command while still executing the current command, the next radial position can be derived from the next command. It is also possible that one command comprises more than one read-write-actions. For instance, the command can contain the instruction to read information that is distributed over several different locations on the information disc. In that case the read-write-head is positioned on several different radial positions within one command.

In an other embodiment of the method of the invention the information disc contains remapped information which is relocated from a first location to a second location, and in that the second location is known while reading information located immediately before the first location, and where the target rotation speed is determined on the basis of the second location. The remapping of information is done for instance, when it is established that the information contains possible errors. Detection of possible errors can be based on e.g. excessive servo signals or error flags from the error correction system during reading. The second location of the remapped information is stored on the information disc. For instance, before the first location where the information originally was located. When the second location is read from the information disc, the target rotation speed can also be determined. Then the current rotation speed can be adjusted towards the target rotation speed on a moment before the read-write-head jumps to the next radial position, thereby gaining time.

Similarly, in a further embodiment of an apparatus according to the invention the information disc contains remapped information which is relocated from a first location to a second location, and in that the handling means are arranged to retrieve the second location from the information disc, and in that the retrieving means are arranged to determine the next radial location based on the retrieved second location.

An example of a remapping strategy is the Mount Rainier strategy. The Mount Rainier strategy is defined in ‘CD-MRW Defect Management & Physical Formatting’ Version 1.1 of August 2001.

When the target rotation speed is lower than the current rotation speed, then the current rotation speed can be reduced by allowing the information disc to decrease its current rotational speed by its own motion. Normally the rotation speed of the information disc is decrease by actively braking the rotation means. This results in a fast reduction of rotation speed. In this embodiment the rotation speed of the information disc is not actively reduced, but the rotation speed is reduced automatically due to friction. This has the advantage that less power is needed for reducing the rotation speed. However, the time needed to arrive at the target rotation speed may be longer than when the current rotation speed is actively reduced. A balance can be achieved between the time gain and the power reduction.

These and other aspects of the invention will be apparent from and elucidated further with reference to the embodiment described by way of example in the following description and with reference to the accompanying drawings, in which

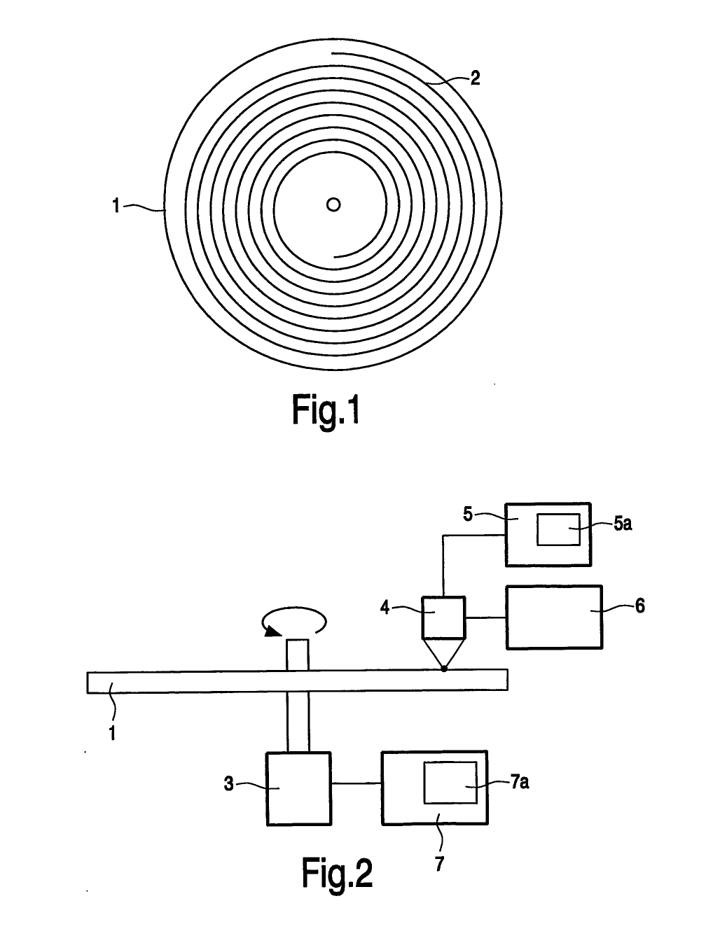

FIG. 1 shows an information disc, top view,

FIG. 2 shows an embodiment of the apparatus according to the invention,

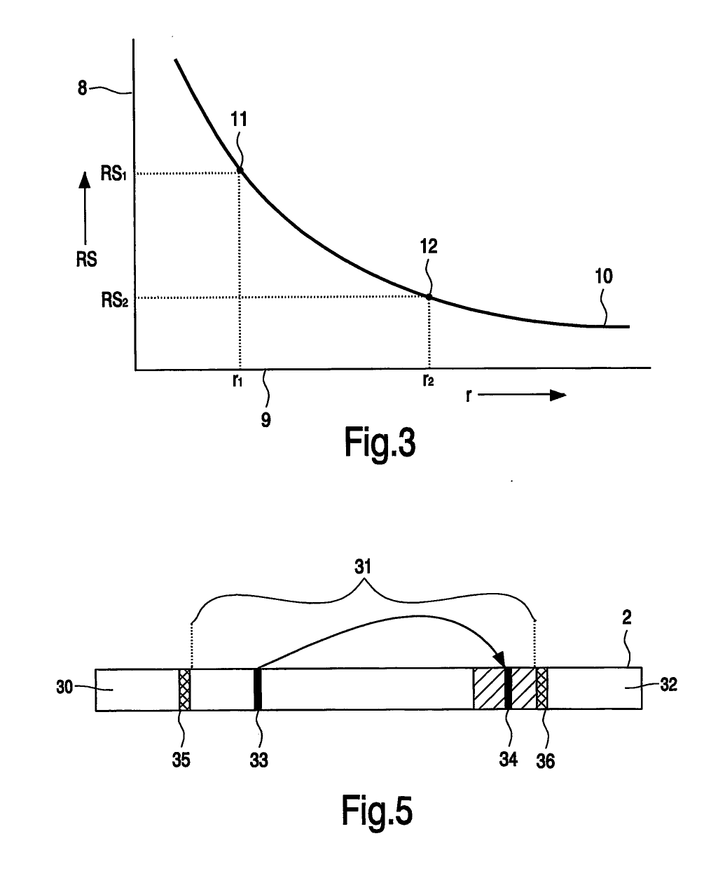

FIG. 3 shows a graphic of the relation between the radius and the rotation speed when rotating the information disc at a constant linear velocity,

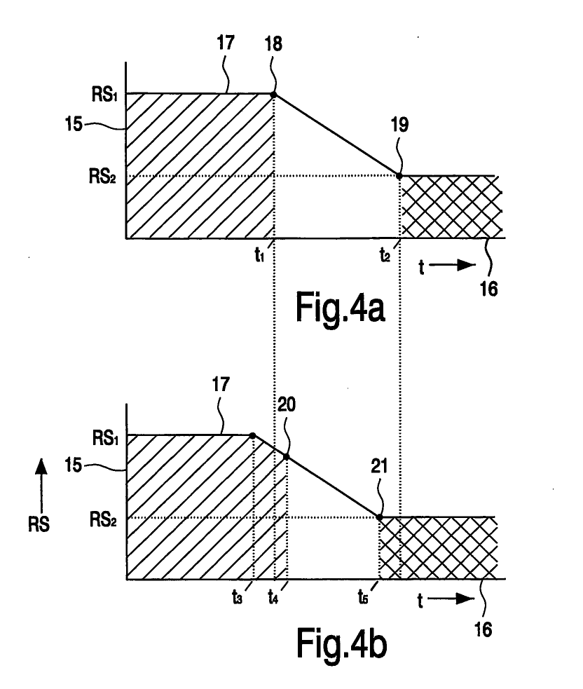

FIG. 4a shows a graph of the linear velocity as a function of time when jumping from an inner track to an outer track, performed with a prior art method,

FIG. 4b shows a graph of the linear velocity as a function of time when jumping from an inner track to an outer track, performed with the method of the invention,

FIG. 5 shows an illustration of an information track with defect tables.

The example of the information disc 1 in FIG. 1 has a spiral information track 2 extended over its surface. It is also possible to have several concentric circles as an information track 2. The radius of the concentric circles increases as they are positioned further outward on the information disc. On the information track 2 information can be recorded and or reproduced. There are information discs 1 which are prerecorded with information and the information can only be read from the information disc 1. An example of such a disc is a CD-ROM disc. There are also information discs 1 which initially contain no user information, but can be recorded with information later. An example of such a disc is a CD-RW disc. A CD rewriter is an apparatus that can record and reproduce information on such a information disc 1. A more recent development of information discs are DVD (Digital Versatile Disc) discs. There are Recordable discs (DVD+R and DVD-R), and rewritable discs (DVD+RW and DVD-RW).

The embodiment of the apparatus according to the invention shown in FIG. 2 has rotating means 3 for rotating the information disc 1. A read-write-head 4 can perform read-write-actions on the information disc 1. In this example the read-write-head 4 can both read and write from and to the information disc 1, but for the apparatus of the invention a read-write-head 4 that can only read or write is sufficient. The read-write-head 4 must follow the information track 2. Radial servo means 6 move the read-write-head 4 in radial direction so that the read-write-head 4 keeps following the information track 2. For performing read-write-actions, information is fed to or taken from the read-write-head 4 by handling means 5. When reading, the handling means 5 take care of recovering the information by digitizing the signal coming from the read-write-head 4 and performing error corrections. When writing, the handling means 5 take care of encoding the information and controlling the read-write-head 4 using a certain write strategy. The rotating means 3 are controlled by controlling means 7. The controlling means 7 control the rotating means 3 such that the linear velocity is constant. With linear velocity is meant the speed at which the information passes the read-write-head 4.

The density at which the information is written to the information disc 1 is constant, i.e. the amount of information within a unit length of the information track 2 is constant along the information track 2. This means that the rotation speed of the information disc 1 must be higher when the read-write-head 4 is at an inner part of the information track 2 compared to when the read-write-head 4 is on an outer part of the information track 2. The linear velocity (LV) is related to the rotation speed (RS) according to equation 1.
LV=2π·RS·R Equation 1
Where R is the distance (radius) between the position of the read-write-head 4 and the point of rotation of the information disc. Thus, in order to achieve constant linear velocity (CLV), the rotation speed RS must decrease inverse proportional with increasing radius R. In FIG. 3 the rotation speed RS as function of the radius R is depicted. On the horizontal axis 9 the radius R is extended, and on the vertical axis 8 the rotation speed RS is extended. In order to achieve a constant linear velocity (CLV) the rotation speed RS decreases inversely proportional to the radius R, as can be seen by the curve 10. On point 11 the read-write-head is positioned on radius r₁ and the information disc 1 has a rotation speed RS₁. On point 12 the read-write-head is positioned on radius r₂ and the information disc 1 has a rotation speed RS₂. When the read-write-head 4 has to jump from point 11 to point 12, the rotation speed has to be reduced from rotation speed RS₁ to rotation speed RS₂ in order to keep the linear velocity at the constant level.

In FIG. 4a a curve 17 is shown which illustrates how the rotation speed reduces in time when using the prior art method. On the horizontal axis 16 the time is extended and on the vertical axis the rotation speed is extended. At point 18 the current read-write-action is finished and on point 19 the next read-write-action starts. The rotation speed at point 18 is RS₁ at time instant t₁. The rotation speed at point 19 is RS₂ at time instant t₂. In FIG. 4a the rotation speed before arriving at point 18 is constant. In reality the rotation speed reduces in time in order to keep the linear velocity constant. When the current read-write-action has finished on time instant t₁ the rotation speed RS₁ is reduced to rotation speed RS₂ at time instant t₂.

In FIG. 4b a curve 17 is shown which illustrates how the rotation speed reduces in time when using the method according to the invention. The horizontal axis 16 and the vertical axis 15 again indicate time and rotation speed. Now the rotation speed is reduced at time instant t3 before the current read-write-action is finished. So the current read-write-action has to finish with a lower rotation speed. Therefore, it will take longer for the current read-write-action to finish. At point 20 at time instant t₄ the current read-write-action has finished, later than time instant t₁. On time instant t₅ at point 21 the rotation speed is at the target rotation speed RS₂, and the next read-write-action is started. Time instant t₅ is earlier in time than time instant t₂. This is because the reduction in speed is started at an earlier point in time. Although the current read-write-action has finished later compared to the prior art method, the net result is that there is a net gain in time. Of course, if the next read-write-action is capable to be performed at a higher speed than the target rotation speed RS₂, then the next read-write-action can be started earlier, resulting in more time gain. In order to already adjust the current rotation speed towards the target rotation speed before the current read-write-action has finished, the target rotation speed must be known before ending the current read-write-action. The target rotation speed is known if the next radial position is known. Therefore, the controlling means 7 have retrieving means 7a for retrieving the next radial position while still performing the current read-write-action.

The range of rotation speeds at which a read-write-action can still be performed correctly depends on the kind of read-write-action. In practice read actions allow for a larger range of rotation speeds than write actions. Writing will normally have to take place at the correct speed for that particular location.

The apparatus according to the invention can be used in computer systems to store and retrieve files. One file can be stored on the information track 2 on several different locations. Therefore, when reading or writing a file from or to an information disc 1, the read-write-head 4 has to jump to different radial positions to retrieve or write the file. The radial positions of the different locations can be retrieved by the retrieving means 7a by using file information on the information disc. From this an optimal rotation speed behavior can be calculated. The ‘optimal’ behaviour can refer to different goals, such as read the entire file as soon as possible, or keep the maximum rotation speed as low as possible (while completing the commands before time x).

The apparatus according to the invention can be coupled to information processing means. The information processing means give commands to the apparatus for performing one or more read-write-actions. Therefore, the handling means 5 in a further embodiment comprise storing means 5a for storing a next command. The next command is used by the retrieving means 7a to determine the next radial position. The information processing means can be a computer system. An example of the commands send by the computer system are commands from the ATAPI command set.

In the embodiment of the apparatus according to the invention where the controlling means 7 are able to decrease the current rotation speed by allowing the information disc 1 to decrease its current rotational speed by its own motion the time to reduce the current rotation speed to the target rotation speed is longer than when it would be actively decreased. As a result the time difference between time instances t₅ and time instant t₄ as depicted in FIG. 4b will be higher. This may mean that no time gain is achieved in comparison with the situation depicted in FIG. 4a where the current rotation speed was reduced actively. But instead of gaining time, a gain in power consumption is achieved. The rotating means 3 does not need power during the decreasing of the current rotation speed, resulting in a reduced power consumption while still performing with a reasonable access performance.

In FIG. 5 a representation of an information track 2 is shown. The information track 2 has a lead in area 30, a lead out area 32 and a user data area 31. In the so called Mount Rainier defect management a piece of information 33 which is defective is replaced to an other location 34 on the information track 2. Furthermore, on the information track 2 a defect table 35 is written. In the defect table 35 information is stored to what location the defective information has been replaced. In order to ensure that this table is not lost, a copy 36 of the defect table 35 is written on the information track 2. In an embodiment of the apparatus according to the invention the handling means 5 are able to obtain the locations of the replaced information and the retrieving means 7a are able to determine the next radial location based on the obtained locations.

1. Method for recording and/or reproducing information on an information track of an information disc, comprising the steps of:
a. directing a read-write-head to a current radial position along of the information disc,
b. rotating the information disc about a point of rotation, where the rotation speed is controlled in dependence of the current radial position of the read-write-head such that the information passes the read-write-head at a predetermined constant linear velocity, at least for a part of the information track,
c. performing a current read-write-action at the current radial position,
d. directing the read-write-head to a next radial position along the information disc, where the rotation speed is controlled such that a current rotation speed is changed to a target rotation speed to attain said predetermined constant linear velocity at the next radial position,
e. performing a next read-write-action at the next radial position,
characterized in that the method further comprises the steps of
f. determining the next radial position of the read-write-head while still performing the current read-write-action,
g. determining the target rotation speed on the basis of the next radial position,
the current rotation speed being changed towards the target rotation speed while the current read-write-action is still being performed.

2. Method as claimed in claim 1, characterized in that the current rotation speed is changed towards the target rotation speed such that at the end of the current read-write-action the rotation speed is just within limits at which the current read-write action can be performed correctly.

3. Method as claimed in claim 1, characterized in that the next read-write action is started before the target rotation speed has been reached.

4. Method as claimed in claim 3, characterized in that the next read-write action is started immediately when the current rotation speed is within limits at which the next read-write-action can be performed correctly.

5. Method as claimed in claim 1, characterized in that the method performs the steps a to g when receiving a command to read a file and in that the next radial position is retrieved from a file system indicating locations of different parts of the file on the information disc.

6. Method as claimed in claim 1, characterized in that method further comprises a step of receiving commands from information processing means where the commands contain at least one read-write-action instruction, where a next command is already received while still executing a current command, and in that the next radial position is derived from the next command.

7. Method as claimed in claim 1, characterized in that the information disc contains remapped information which is relocated from a first location to a second location, and in that the second location is known while reading information located immediately before the first location, and where the target rotation speed is determined on the basis of the second location.

8. Method as claimed in claim 7, characterized in that the remapping of information is performed by the so called Mount Rainier strategy.

9. Method as claimed in claim 1, characterized in that in step d the decreasing is performed by allowing the information disc to decrease its current rotational speed by its own motion.

10. Apparatus for recording and/or reproducing information on an information track of an information disc, comprising:
a read-write-head for performing read-write-actions on the information disc;
handling means for controlling the read-write-actions;
radial servo means for moving said read-write-head along a radial direction of the information disc;
rotation means for rotating said information disc about a point of rotation;
controlling means for controlling the rotation means where the controlling means control the current rotation speed in dependence of a current radial position of the read-write-head such that the information passes the read-write-head at a constant linear velocity, at least for a part of the information track, and where the controlling means are arranged to change the current rotation speed suitable for a current read-write-action on a current radial position to a target rotation speed suitable for a next read-write-action on a next radial position,
characterized in that the controlling means comprise retrieving means for retrieving the next radial position while still performing the current read-write-action and in that the controlling means are arranged to change the current rotational speed towards the target rotation speed before the current read-write-action has ended.

11. Apparatus as claimed in claim 10, characterized in that the controlling means are arranged to adapt the current rotation speed towards the target rotation speed such that at the end of the current read-write-action the rotation speed is just within limits at which the current read-write action can be performed correctly.

12. Apparatus as claimed in claim 10, characterized in that the handling means are arranged to start the next read-write action before the target rotation speed has been reached.

13. Apparatus as claimed in claim 12, characterized in that the handling means are arranged to start the next read-write action immediately when the current rotation speed is within limits at which the next read-write-action can be performed correctly.

14. Apparatus as claimed in claim 10, characterized in that the information disc comprises file information which indicates locations of different parts of a file and in that the apparatus further comprises file information retrieving means for retrieving the file information and in that the retrieving means are arranged to determine the next radial position based on the retrieved file information.

15. Apparatus as claimed in claim 10, characterized in that the handling means are arranged to receive commands containing at least one read-write-action instruction, and where the handling means comprise storing means for storing a next command, and in that the retrieving means are arranged to determine the next radial position based on the next command.

16. Apparatus as claimed in claim 10, characterized in that the information disc contains remapped information which is relocated from a first location to a second location, and in that the handling means are arranged to retrieve the second location from the information disc, and in that the retrieving means are arranged to determine the next radial location based on the retrieved second location.

17. Apparatus as claimed in claim 16, characterized in that the remapping of information is performed by the so called Mount Rainier strategy.

18. Apparatus as claimed in claim 10, characterized in that the controlling means are able to decrease the current rotation speed by allowing the information disc to decrease its current rotational speed by its own motion.
